(19) United States
(12) Patent Application Publication
(10) Pub. No.: US 2012/0007832 A1
(43) Pub. Date: Jan. 12, 2012

(54) TOUCH SENSOR DEVICE

(75) Inventors: Jei-Hyuk Lee, Yongin-si (KR); Duck-Young Jung, Yongin-si (KR); Jin-Woo Chung, Yongin-si (KR); Se-Eun Jang, Yongin-si (KR)

(73) Assignee: ATLAB INC., Yongin-si (KR)

(21) Appl. No.: 13/255,194

(22) PCT Filed: Oct. 22, 2009
(86) PCT No.: PCT/KR09/06132

§ 371 Date: Sep. 7, 2011

(30) Foreign Application Priority Data
Apr. 1, 2009 (KR) 10-2009-0028199

(51) Int. Cl. G06F 3/044; G06F 3/045

(52) U.S. Cl. 345/174; 178/18.06; 178/18.05

(57) ABSTRACT

A touch sensor device includes first touch pads, each of which is connected with a first bar-type touch pattern and a second bar-type touch pattern by a plurality of bridges and is disposed in a first direction, the first and second bar-type touch patterns being connected with first and second channels at opposite ends thereof and third and fourth channels at opposite ends thereof respectively, second touch pads, each of which is connected with fifth and sixth channels at opposite ends thereof respectively and is disposed in a second direction perpendicular to the first direction, and a touch sensor sequentially applying reference signals to the second and fourth channels of the first touch pads, performing resistor-type and capacitor-type touch sensing using resistance and capacitance values varied depending on the touch location of a touch object, and generating touch location data corresponding to the touch location.

### TECHNICAL FIELD

The present invention relates to a touch sensor device and, more particularly, to a touch sensor device capable of detecting resistance and capacitance values varied on a touch pad to which a touch object is touched, and determining a touch location of the touch object.

### BACKGROUND ART

A touch pad is one among various data input devices. In a touch pad, a plurality of sensing points are arranged on a plane in a matrix form, and a location that a user presses and a direction in which a touch location moves are detected through the sensing points. Thus, the touch pad is widely used in place of a mouse. The touch pad includes various types, for examples, a type in which electric switches are arranged on a plane, a type in which capacitor type sensors, resistor type sensors, surface wave sensors, or optical sensors are arranged on a plane. Among these, to adjust movement of a cursor in a laptop computer, a touch panel including the touch pad of the capacitor type sensors is widely used. This touch panel is configured such that a surface thereof is covered with an insulating layer under which longitudinal and transverse lines are arranged at regular intervals. There are capacitances between the longitudinal and transverse lines as electrical equivalent circuits. Each transverse line serves as a first channel, and each longitudinal line serves as a second channel.

When a kind of conductive object such as a finger touches a sensing surface, a value of capacitances detected at the longitudinal and transverse lines are different from that of capacitances detected at touch-free longitudinal and transverse lines. For example, a voltage signal is applied to the transverse line, and an induced voltage is read out of the longitudinal line. Thereby, changes in capacitance are detected, so that the location of which the sensing surface is touched can be found.

A resistor type 2D matrix touch panel, which is another kind of touch panel, is configured such that conductive conductors are disposed on two layered films, between which a space is placed at a minute interval. Thus, no short occurs at normal times. However, when a user presses a predetermined touch region of the touch panel using his/her finger, the conductors between the two layers of the touch region are shorted, and electric potential or current of the shorted location is detected to recognize touch coordinates.

At this time, a binary signal can be generated whether or not the conductors (e.g. conductive bars) between the two layers are shorted, i.e. an on/off signal is generated in a multi-touch resistor type touch panel. Many binary signals are distributed around the touch region as wide as the finger, so that the coordinates of the specified touch region are determined.

This touch panel has recently been mounted on and used for portable communication appliances such as mobile phones, personal digital assistants (PDAs), portable multimedia players (PMPs), laptop computers, and car navigation systems, as well as household electric appliances such as kitchen appliances or humidifiers.

### DISCLOSURE

### Technical Problem

The present invention is directed to a touch sensor device capable of recognizing both a resistor-type multi-touch and a capacitor-type multi-touch, and diversifying a touch pattern.

### Technical Solution

According to example embodiments, there is provided a touch sensor device, which includes a plurality of first touch pads, each of which is connected with a first bar-type touch pattern and a second bar-type touch pattern by a plurality of bridges and is disposed in a first direction, the first bar-type touch pattern having a plurality of slits and being connected with first and second channels at opposite ends thereof respectively, the second bar-type touch pattern being connected with third and four channels at opposite ends thereof respectively, a plurality of second touch pads, each of which is connected with fifth and sixth channels at opposite ends thereof respectively and is disposed in a second direction perpendicular to the first direction, and a touch sensor sequentially applying reference signals to the second and fourth channels of each of the first touch pads, performing resistor-type touch sensing and capacitor-type touch sensing using resistance and capacitance values, which are varied depending on the touch location of a touch object, and generating touch location data corresponding to the touch location.

According to other example embodiments, there is provided a touch sensor device, which includes a plurality of first touch pads, each of which is connected with first and second channels at opposite ends thereof, undergoes a decrease in area in a first direction, and is disposed in a second direction perpendicular to the first direction, a plurality of second touch pads, each of which makes a pair with each of the first touch pads, is connected with third and fourth channels at opposite ends thereof, undergoes an increase in area in the first direction, and is disposed in the second direction, the third and fourth channels being disposed on the same plane as the first touch pads, a plurality of third touch pads, each of which is connected with fifth and sixth channels at opposite ends thereof, extends in a bar-type touch pattern in the second direction, and is disposed in the first direction, the fifth and sixth channels being disposed on a plane different from those of the first and second touch pads, and a touch sensor sequentially applying reference signals to the first and fourth channels or the second and third channels, performing resistor-type touch sensing and capacitor-type touch sensing using resistance and capacitance values, which are varied depending on the touch location of a touch object, and generating touch location data corresponding to the touch location.

According to still other example embodiments, there is provided a touch sensor device, which includes a plurality of first touch pads, each of which has a plurality of touch patterns disposed in a first direction, is disposed in a second direction perpendicular to the first direction, and is connected with first and second channels at opposite ends thereof, a plurality of second touch pads, each of which is connected with third and fourth channels at opposite ends thereof, extends in the second direction, and is disposed in the first direction, and a touch sensor applying a reference signal to one end of each of the first touch pads to receive a first delay reference signal output from the other end of each of the first touch pads, applying the reference signal to the other end of each of the first touch pads to receive a second delay reference signal output from one end of each of the first touch pads, performing resistor-type touch sensing and capacitor-type touch sensing using delay time differences between the reference signal and the first delay reference signal and between the reference signal and the second delay reference signal, and generating touch location data corresponding to the touch location of a touch object.

### Advantageous Effects

According to example embodiments, the touch sensor device can perform a high-resolution in a resistor-type touch sensing function and a relatively low-resolution in a capacitor-type touch sensing function touch sensing, detect two or more touch locations of a touch object at the same time, and accurately obtain the touch locations regardless of noise or offset

### DESCRIPTION OF DRAWINGS

FIG. 1 illustrates the configuration of a touch sensor device having resistor type multi-touch sensing function and capacitor type touch sensing function according to a first embodiment of the inventive concept.

FIG. 2 illustrates the first touch pad Py1 of the upper sheet pad 120 of the touch panel 100 illustrated in FIG. 1, wherein FIG. 2A is an enlarged view and FIG. 2B is an equivalent circuit diagram.

FIG. 3 illustrates the configuration of a touch sensor device having resistor-type multi-touch sensing function and capacitor-type touch sensing function according to a second embodiment of the inventive concept.

FIG. 4 illustrates the configuration of a touch sensor device having resistor-type multi-touch sensing function and capacitor-type touch sensing function according to a third embodiment of the inventive concept.

FIG. 5 illustrates the construction of a touch sensor device having resistor-type multi-touch sensing function and capacitor-type touch sensing function according to a fourth embodiment of the inventive concept.

FIG. 6 illustrates the construction of a touch sensor device having resistor-type multi-touch sensing function and capacitor-type touch sensing function according to a fifth embodiment of the inventive concept.

FIG. 7 illustrates the construction of a touch sensor device having resistor-type multi-touch sensing function and capacitor-type touch sensing function according to a sixth embodiment of the inventive concept.

FIG. 8 illustrates the construction of a touch sensor device having five wire resistor-type multi-touch sensing function and capacitor-type touch sensing function according to a seventh embodiment of the inventive concept.

FIG. 9 illustrates the construction of a touch sensor device having five wire resistor-type multi-touch sensing function and capacitor-type touch sensing function according to a eighth embodiment of the inventive concept.

### MODE FOR INVENTION

Reference will now be made in greater detail to a touch sensor device and a method of determining pointing coordinates of the same according to example embodiments of the inventive concept with reference to the accompanying drawings.

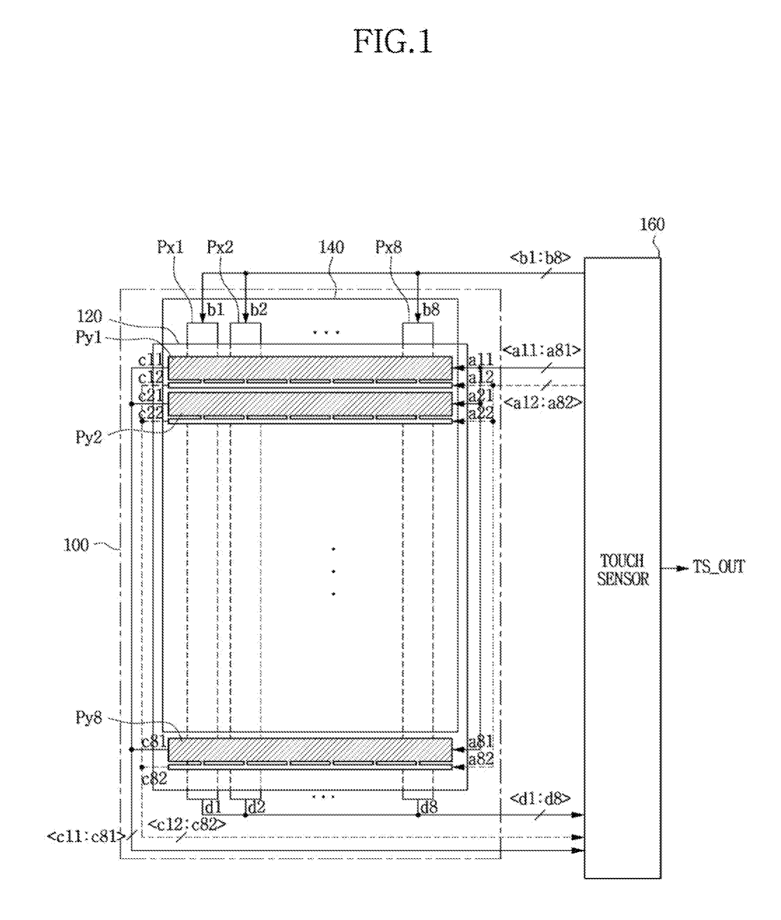

FIG. 1 illustrates the configuration of a touch sensor device having resistor type multi-touch sensing function and capacitor type touch sensing function according to a first embodiment of the inventive concept. The touch sensor device includes a touch panel 100 and a touch sensor 160. The touch panel 100 includes an upper sheet pad 120, a plurality of first touch pads Py1, Py2 . . . , a plurality of first left-hand channels <c11:c81>, a plurality of second left-hand channels <c12:c82>, a plurality of first right-hand channels <a11:a81>, a plurality of second right-hand channels <a12:a82>, a lower sheet pad 140, a plurality of second touch pads Px1, Px2 . . . , a plurality of upper channels <b1:b8>, and a plurality of lower channels <d1:d8>.

Referring to FIG. 1, the upper sheet pad 120 has the plurality of first touch pads Py1, Py2 . . . extending in an x-axial direction and arranged in a y-axial direction, while the lower sheet pad 140 has the plurality of second touch pads Px1, Px2 . . . extending in the y-axial direction and arranged in the x-axial direction.

Here, the upper sheet pad 120 is illustrated to have eight first touch pads Py1, Py2 . . . Py8, and the lower sheet pad 140 is illustrated to have eight second touch pads Px1, Px2 . . . Px8. However, the upper sheet pad 120 and the lower sheet pad 140 may have as many of the first touch pads and the second touch pads as needed, respectively.

For example, the upper sheet pad 120 may be configured to have only one first touch pad. The lower sheet pad 140 may be configured to have two or more second touch pads.

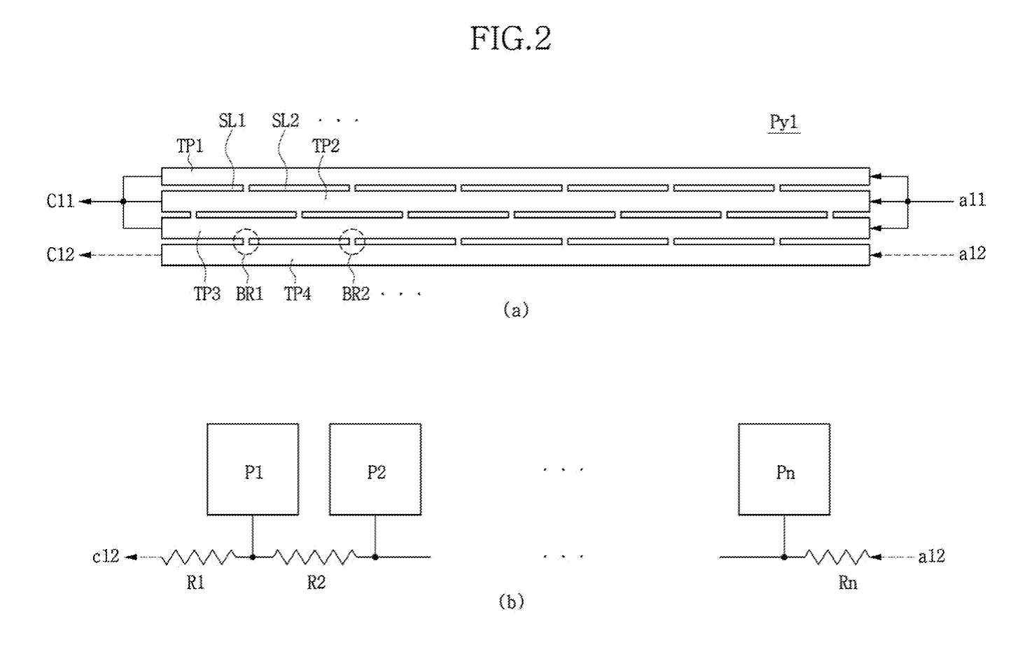

FIG. 2 illustrates the first touch pad Py1 of the upper sheet pad 120 of the touch panel 100 illustrated in FIG. 1, wherein FIG. 2A is an enlarged view and FIG. 2B is an equivalent circuit diagram. In the enlarged view (FIG. 2A) illustrating the first touch pad Py1, the first touch pad Py1 includes first to fourth bar-type touch patterns TP1 to TP4 and a plurality of bridges BR1, BR2 . . . , and in the equivalent circuit diagram (FIG. 2B) illustrating the first touch pad Py1, the first touch pad Py1 includes a plurality of capacitive sensing touch pads P1, P2 . . . and a plurality of resistors R1, R2 . . . .

Here, for the convenience of understanding, it is assumed that the number of bar-type touch patterns TP1 to TP4 is four.

In the enlarged view (FIG. 2A), opposite ends of the first to fourth bar-type touch patterns TP1 to TP4 of the first touch pad Py1 are provided with first and second left-hand channels c11 and c12, and first and second right-hand channels a11 and a12, respectively. The first to fourth bar-type touch patterns TP1 to TP4 are interconnected by a plurality of bridges BR1, BR2 . . . . This connection provides a plurality of slits SL1, ST2 . . . between the first to fourth bar-type touch patterns TP1 to TP4. A width of each of the slits SL1, SL2 . . . must be smaller than the size of a tip of a stylus touched to the touch panel 100. Meanwhile, in a capacitor type operation mode, a resolution of the touch panel 100 is determined by the number of bridges BR1, BR2 . . . .

In the equivalent circuit diagram (FIG. 2B), the first to third bar-type touch patterns TP1 to TP3 of the first touch pad Py1 may be replaced with capacitive sensing touch pads P1, P2 . . . , and the fourth bar-type touch pattern TP4 is connected in series with a plurality of resistors R1, R2 . . . Rn. As a result, the first touch pad Py1 may be replaced with a circuit in which the resistors R1, R2 . . . Rn are respectively connected in parallel with the respective capacitive sensing touch pads P1, P2 . . . .

Here, the reason why the bridges BR1, BR2 . . . are required is to increase a resistance value by parallel-connecting the resistors between the bridges of the fourth bar-type touch pattern TP4 with resistors caused by the first to third bar-type touch patterns TP1 to TP3, thereby performing a capacitor-type touch sensing operation using the capacitive sensing touch pads P1, P2 . . . when a touch object such as a finger is touched.

The operation of a touch sensor device having resistor-type multi-touch sensing function and capacitor-type touch sensing function according to a first embodiment of the inventive concept will be described below with reference to FIGS. 1 and 2.

The touch panel 100 according to the first embodiment of the inventive concept can simultaneously recognize a resistor-type multi-touch and a capacitor-type touch The resistor-type multi-touch enables high-resolution touch sensing using a stylus, and the capacitor-type touch enables low-resolution touch sensing using a finger.

In the case of the resistor-type multi-touch, touch locations are detected using a change in resistance rather than a change in capacitance. When a user touches the stylus to the touch panel 100, a given point of the upper sheet pad 120 pressed by the stylus is contacted with a point of the lower sheet pad 140. Hereinafter, this contacted point is referred to as a touch point. At this time, the opposite ends of the first to fourth bar-type touch patterns TP1 to TP4 of each of the first touch pads Py1, Py2 . . . disposed on the upper sheet pad 120 are shorted, thereby using the first to fourth bar-type touch patterns TP1 to TP4 as one pattern. In detail, the first to fourth bar-type touch patterns TP1 to TP4 are configured to short the first left-hand channel <c11:c81> and the second left-hand channel <c12:c82> and to short the first right-hand channel <a11:a81> and the second right-hand channel <a12:a82>.

The touch sensor 160 applies reference signals to the first to fourth bar-type touch patterns TP1 to TP4 of the upper sheet pad 120 through the first right-hand channel <a11:a81> and the second right-hand channel <a12:a82>, and sequentially connects delay nodes (not shown) of the touch sensor with upper channels <b1:b8> of the of the lower sheet pad 140, thereby receiving output signals. Further, the touch sensor 160 sequentially connects the delay nodes of the touch sensor with lower channels <d1:d8> of the lower sheet pad 140, thereby receiving output signals. This process is repeated for each group of the first to fourth bar-type touch patterns TP1 to TP4.

Next, the touch sensor 160 sequentially applies reference signals to the upper channels <b1:b8> of the lower sheet pad 140, and sequentially connects the delay nodes with the first and second right-hand channels <a11:a81> and <a12:a82> of the upper sheet pad 120, thereby receiving output signals. Further, the touch sensor 160 sequentially connects the delay nodes with the first and second left-hand channels <c11:c81> and <c12:c82> of the upper sheet pad 120, thereby receiving output signals. This process is repeated for each of the upper channels <b1:b8>.

In this manner, the touch sensor 160 measures delay times of the output signals with respect to each case, calculates resistance values using the measurements, and then calculates coordinates of a touch location through these resistance values.

Meanwhile, the touch sensor device according to the first embodiment of the inventive concept is configured such that the upper sheet pad 120 and/or the lower sheet pad 140 each have the multiple touch pads. Thus, when two or more touch locations occur on the touch panel 100 at the same time, the touch sensor device can sense these touch locations.

For example, when the upper sheet pad 120 has one touch pad and the lower sheet pad 140 has two touch pads, and two touch locations occur at the same time, the touch sensor device may sequentially apply reference signals to two touch pads, thereby detecting two touch locations. When the upper sheet pad 120 and the lower sheet pad 140 each have two touch pads, the touch sensor device may detect four touch locations at the same time. Here, the number of touch pads is determined by the fragmented spacing of a multi-touch. Because the typical multi-touch is activated by a finger, a spacing between the touch pads is configured to be set to 5 mm smaller than a spacing between the fingers.

In the case of a capacitor-type multi-touch, the touch locations are detected using a change in capacitance rather than a change in resistance. Here, as illustrated in the equivalent circuit diagram (FIG. 2B), the touch location is detected through the first to third bar-type touch patterns TP1 to TP3, which are replaced with the capacitive sensing touch pads P1, P2 . . . .

In detail, the first to third bar-type touch patterns TP1 to TP3, which are allocated to each of the first touch pads Py1, Py2 . . . of the upper sheet pad 120 as illustrated in FIG. 1, are interconnected by the bridges BR1, BR2 . . . . Thus, as illustrated in FIG. 2, the first to third bar-type touch patterns TP1 to TP3 operate as the capacitive sensing touch pads P1, P2 . . . . Further, the fourth bar-type touch pattern TP4 is connected with a signal line receiving first and second reference signals at opposite ends thereof, thereby operating as the resistors R1, R2 . . . .

Here, the capacitive sensing is determined by the resistance value of the fourth bar-type touch pattern TP4 and touch capacitance values of the first to third bar-type touch patterns TP1 to TP3.

The fourth bar-type touch pattern TP4 is connected in parallel with the capacitive sensing touch pads P1, P2 . . . . Thus, the touch sensor 160 can detect delay times of the first and second reference signals, which vary depending on locations where the user's finger touches the capacitive sensing touch pads P1, P2 . . . , thereby determining the touch location of the touch object.

More specifically, the first reference signal applied to the second right-hand channel a12 is delayed depending on capacitance between the second right-hand channel a12 and the location where the touch pad is touched by the user's finger. Further, the second reference signal applied to the second left-hand channel c12 is delayed depending on capacitance between the second left-hand channel c12 and the location where the touch pad is touched by the user's finger.

Accordingly, the delay times are detected by comparing the delayed first and second reference signals with the non-delayed first and second reference signals, and then an average of values corresponding to the delay times is calculated. Thereby, the touch location of the touch object can be determined.

Mathematically speaking, there are two unknowns of the touch capacitance and the touch location. By measuring delays twice, those two unknowns can be uniquely solved. Up to now, delay time techniques are used to describe for simplicity. It is natural that there are many other techniques to measure touch locations.

Thus, the touch panel 100 according to the first embodiment of the inventive concept can simultaneously recognize the resistor-type multi-touch and the restricted capacitor-type multi-touch, so that both high-resolution touch sensing and low-resolution touch sensing can be performed, and two or more touch locations can be detected.

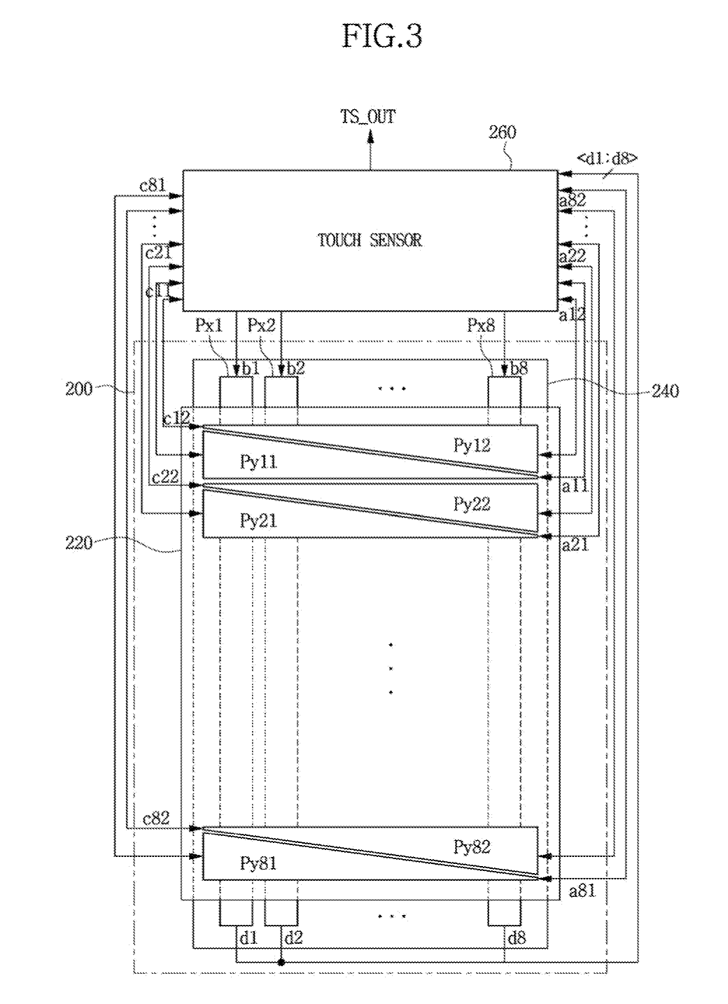

FIG. 3 illustrates the configuration of a touch sensor device having resistor-type multi-touch sensing and capacitor-type touch sensing functions according to a second embodiment of the inventive concept. The touch sensor device includes a touch panel 200 and a touch sensor 260.

The touch panel 200 includes an upper sheet pad 220, a plurality of first touch pad pairs Py11 and Py12, Py21 and Py22 . . . , a plurality of first left-hand channels <c11:c81>, a plurality of second left-hand channels <c12:c82>, a plurality of first right-hand channels <a11:a81>, a plurality of second right-hand channels <a12:a82>, a lower sheet pad 240, a plurality of second touch pads Px1, Px2 . . . , a plurality of upper channels <b1:b8>, and a plurality of lower channels <d1:d8>.

In FIG. 3, the upper sheet pad 220 is configured such that the right-angled triangular first touch pads Py11, Py12, Py21, Py22 . . . are symmetrically disposed in pairs in a y-axial direction. These first touch pad pairs Py11 and Py12, Py21 and Py22 . . . are connected with the touch sensor 260 through the first left-hand channels <c11:c81> and the second left-hand channels <c12:c82>, and the first right-hand channels <a11:a81> and the second right-hand channels <a12:a82>. Further, the lower sheet pad 240 has the second touch pads Px1, Px2 . . . extending in the y-axial direction and arranged in an x-axial direction.

Here, the upper sheet pad 220 is illustrated to have eight first touch pad pairs Py11 and Py12, Py21 and Py22 . . . Py81 and Py82, and the lower sheet pad 240 is illustrated to have eight second touch pads Px1, Px2 . . . Px8. However, the upper sheet pad 220 and the lower sheet pad 240 may have as many of the first touch pad pairs and the second touch pads as needed, respectively.

The operation of the touch sensor device having resistor-type multi-touch sensing function and capacitor-type touch sensing function according to a second embodiment of the inventive concept will be described below with reference to FIG. 3.

First, in the case of capacitor-type multi-touch, when the first touch pad pairs Py11 and Py12, Py21 and Py22 . . . are touched with a finger, capacitance of the touched first touch pad pairs is varied. At this time, the touch sensor 260 generates reference signals by a predetermined logic operation in order to detect a variation of the capacitance of the touched first touch pad pairs, applies the reference signals to opposite ends of each of the first touch pad pairs Py11 and Py12, Py21 and Py22 . . . , measures delay times depending on the variation of the capacitance, and thereby detects the touch location of a touch object.

The eight first touch pad pairs Py11 and Py12 . . . Py81 and Py82 are arranged on the x-axis of the upper sheet pad 220, so that the positions of an x coordinate are determined according to a ratio between capacitance values of the touch pad pairs.

For an example, when a conductive object is touched to the middle between the first touch pad pair Py11 and Py12, touched areas of the first touch pad pair Py11 and Py12 are equal to each other, so that the ratio of the capacitance value obtained from the left-hand channel <c11> to that obtained from the right-hand channel <a12>is 1. Meanwhile, when the conductive object is touched near the left-hand channel <c11>, the ratio of the capacitance value obtained from the left-hand channel <c11> to that obtained from the right-hand channel <a12> is greater than 1. In contrast, when the conductive object is touched near the right-hand channel <a12>, the ratio of the capacitance value obtained from the left-hand channel <c11> to that obtained from the right-hand channel <a12>is smaller than 1.

Further, because the capacitance of the first touch pad pairs Py11 and Py12, Py21 and Py22 . . . arranged on the y-axis of the upper sheet pad 220 varies in a longitudinal order when touched with the touch object, the y coordinate of the touch location is determined in the longitudinal order of the first touch pad pairs whose capacitance is changed.

Here, the determination of the x and y coordinates may be varied depending on arrangement of the first touch pad pairs Py11 and Py12, Py21 and Py22 . . . of the upper sheet pad 220.

Further, precision of the x and y coordinates may be increased by a temporal interpolation technique using a touch time or another spatial interpolation technique using touch values and an initial spatial value obtained in a calibration process.

Meanwhile, when the touch object is touched to some of the first touch pad pairs, all of the x and y coordinates of the touched first touch pad pairs may be determined, and an average value thereof is calculated, so that a plurality of touch locations can be determined.

Further, in the case in which one Py11 of the first touch pad pair Py11 and Py12 and one Py22 of the other first touch pad pair Py21 and Py22 are simultaneously touched, it will be understood that the touch locations of the touch object can be determined in the above-mentioned method.

In the case of the resistor-type multi-touch, the first touch pad pairs Py11 and Py12, Py21 and Py22 . . . of the upper sheet pad 220 are each shorted and connected with the touch sensor 260. In detail, each two touch pads are shorted and used as one rectangular touch pad. At this time, in order to short each of the first touch pad pairs Py11 and Py12, Py21 and Py22 . . . , the touch sensor 260 requires a separate logic, which shorts signal lines of the opposite ends of each touch pad pair.

The touch sensor 260 applies reference signals to the respective first touch pad pairs Py11 and Py12, Py21 and Py22 . . . , which are shorted to have a bar shape, through the first left-hand channels <c11:c81> and the second left-hand channels <c12:c82>, and receives delayed reference signals through the first right-hand channels <a11:a81> and the second right-hand channels <a12:a82>.

More specifically, when the touch object is a stylus, i.e. a resistor-type multi-touch, the opposite ends of each of the first touch pad pairs Py11 and Py12, Py21 and Py22 . . . are shorted (i.e. c11, c21 . . . c81 are connected with c12, c22 . . . c82 respectively, and a11, a21 . . . a81 are connected with a12, a22 . . . a82 respectively), and thus are formed in a bar-shaped pattern, thereby detecting at least one touch location. This configuration is the same as the resistor-type multi-touch of FIG. 1.

In this manner, the touch sensor 260 can detect the delay time of the reference signal which varies depending on the touch position of the touch object, and determine the touch location of the touch object.

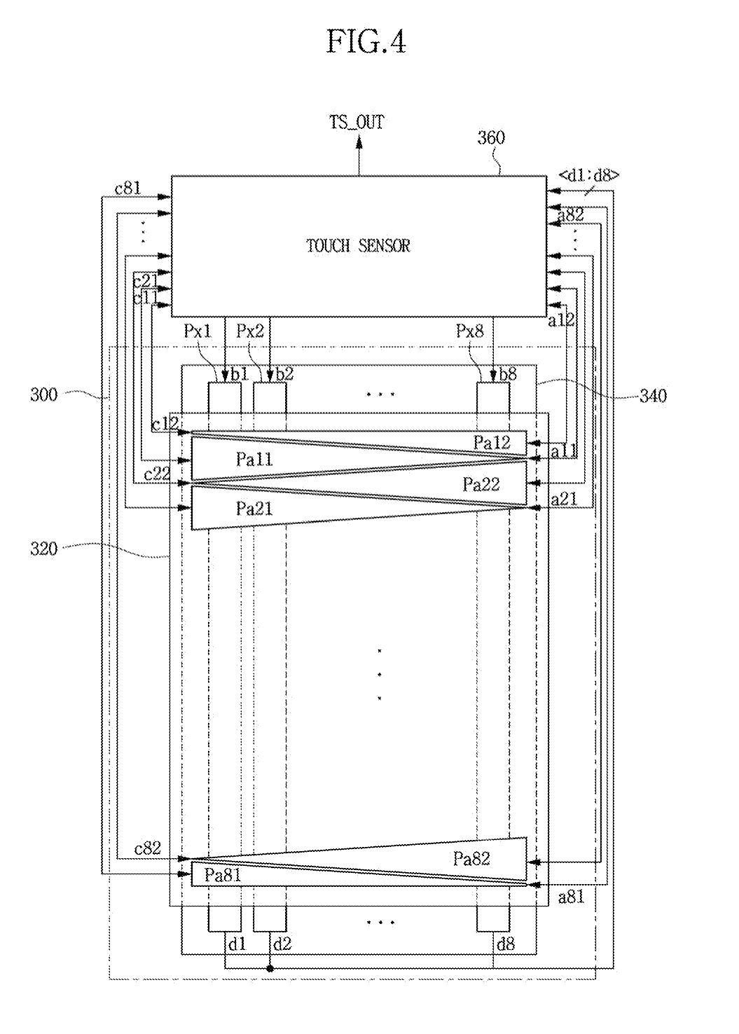

FIG. 4 illustrates the configuration of a touch sensor device having resistor-type multi-touch sensing function and capacitor-type touch sensing function according to a third embodiment of the inventive concept. The touch sensor device includes a touch panel 300 and a touch sensor 360.

The touch panel 300 includes an upper sheet pad 320, a plurality of first touch pad pairs Pa11 and Pa12 through Pa81 and Pa82, a plurality of first left-hand channels <c11:c81>, a plurality of second left-hand channels <c12:c82>, a plurality of first right-hand channels <a11:a81>, a plurality of second right-hand channels <a12:a82>, a lower sheet pad 340, a plurality of second touch pads Px1 through Px8, a plurality of upper channels <b1:b8>, and a plurality of lower channels <d1:d8>.

Further, the upper sheet pad 320 is configured such that the first touch pads Pa11, Pa12 . . . Pa81 and Pa82, each of which has the shape of an isosceles triangle, are alternately and symmetrically disposed in pairs. These first touch pad pairs Pa11 and Pa12 through Pa81 and Pa82 are disposed in a y-axial direction, and are connected with the touch sensor 360 through the first left-hand channels <c11:c81> and the second left-hand channels <c12:c82>, and the first right-hand channels <a11:a81> and the second right-hand channels <a12:a82>. Further, the lower sheet pad 340 includes the second touch pads Px1 through Px8 that extend in the y-axial direction and are disposed in an x-axial direction.

Here, the upper sheet pad 320 is illustrated to have eight first touch pad pairs Pa11 and Pa12 through Pa81 and Pa82, and the lower sheet pad 340 is illustrated to have eight second touch pads Px1 through Px8. However, the upper sheet pad 320 and the lower sheet pad 340 may have as many of the first touch pad pairs and the second touch pads as needed, respectively.

The first touch pad pairs Pa11 and Pa12 through Pa81 and Pa82 of the upper sheet pad 320 of the touch panel 300 of FIG. 4 have the shape of the isosceles triangle, with which the right-angled triangles of the second embodiment are replaced. Thus, the principle that determines the touch location of the touch object is the same as the second embodiment, and so repeated description thereof will be omitted.

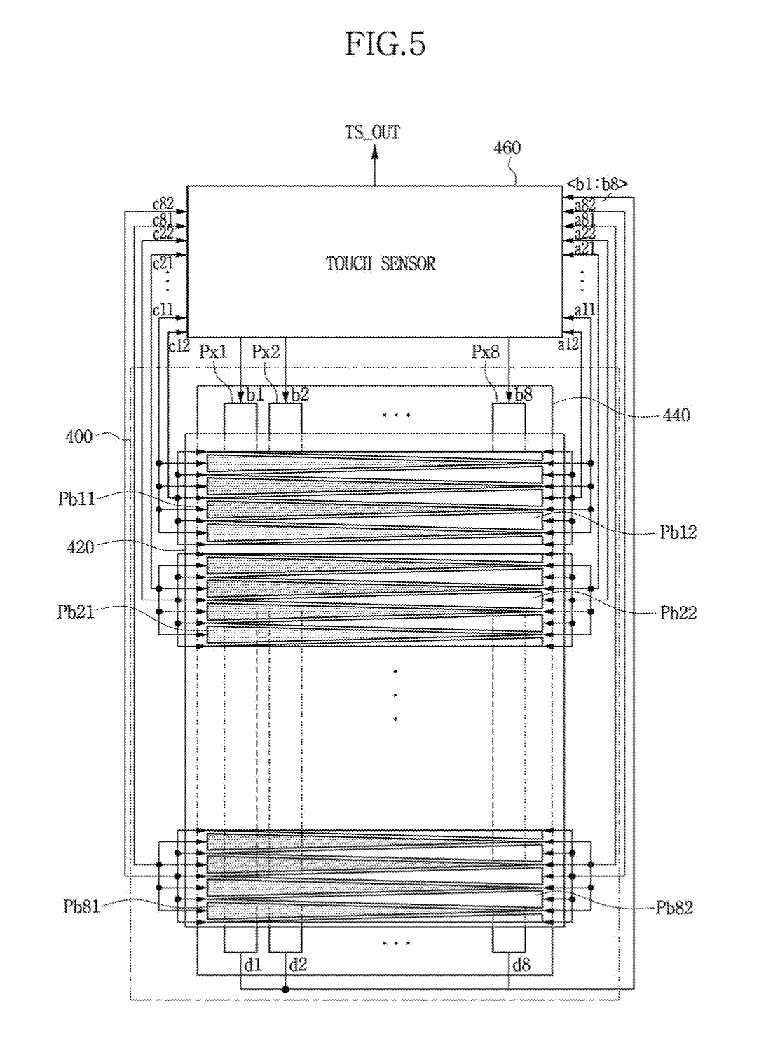

Now, FIG. 5 illustrates the construction of a touch sensor device having resistor-type multi-touch sensing function and capacitor-type touch sensing function according to a fourth embodiment of the inventive concept. The touch sensor device includes a touch panel 400 and a touch sensor 460.

The touch panel 400 includes an upper sheet pad 420, a plurality of first touch pad pairs Pb11 and Pb12 through Pb81 and Pb82, a plurality of first left-hand channels <c11:c81>, a plurality of second left-hand channels <c12:c82>, a plurality of first right-hand channels <a11:a81>, a plurality of second right-hand channels <a12:a82>, a lower sheet pad 440, a plurality of second touch pads Px1 through Px8, a plurality of upper channels <b1:b8>, and a plurality of lower channels <d1:d8>.

Further, the upper sheet pad 420 is configured such that the first touch pads Pb11, Pb12 . . . Pb81 and Pb82, each of which has the shape of a toothed polygon, are alternately and symmetrically disposed in pairs. These first touch pad pairs Pb11 and Pb12 through Pb81 and Pb82 are disposed in a y-axial direction, and are connected with the touch sensor 460 through the first left-hand channels <c11:c81> and the second left-hand channels <c12:c82>, and the first right-hand channels <a11:a81> and second right-hand channels <a12:a82>. Further, the lower sheet pad 440 includes the second touch pads Px1 through Px8 that extend in the y-axial direction and are disposed in an x-axial direction.

Here, the upper sheet pad 420 is illustrated to have eight first touch pad pairs Pb11 and Pb12 through Pb81 and Pb82, and the lower sheet pad 440 is illustrated to have eight second touch pads Px1 through Px8. However, the upper sheet pad 420 and the lower sheet pad 440 may have as many of the first touch pad pairs and the second touch pads as needed, respectively.

The first touch pad pairs Pb11 and Pb12 through Pb81 and Pb82 of the upper sheet pad 420 of the touch panel 400 of FIG. 5 have the shape of the toothed polygon, with which the right-angled triangles of the second embodiment are replaced. Thus, the principle that determines the touch location of the touch object is the same as the second embodiment, and so repeated description thereof will be omitted.

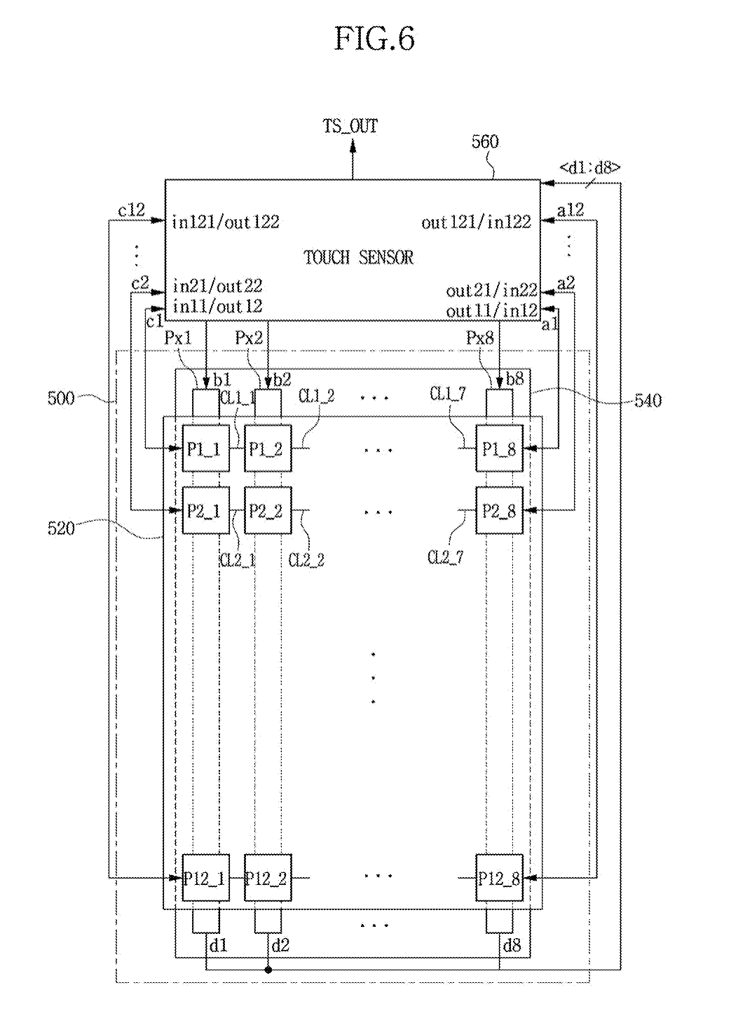

FIG. 6 illustrates the construction of a touch sensor device having resistor-type multi-touch sensing function and capacitor-type touch sensing function according to a fifth embodiment of the inventive concept. The touch sensor device includes a touch panel 500 and a touch sensor 560.

The touch panel 500 includes an upper sheet pad 520, a plurality of first touch pad sets P1_1 through P1_8 . . . P12_1 through P12_8 for multiple channels, a plurality of left-hand channels <c1:c12>, a plurality of right-hand channels <a1:a12>, a lower sheet pad 540, a plurality of second touch pads Px1 through Px8, a plurality of upper channels <b1:b8>, and a plurality of lower channels <d1:d8>.

Further, the upper sheet pad 520 is configured such that the first touch pad sets P1_1 through P1_8 . . . P12_1 through P12_8 for multiple channels are connected in series to respective connection line sets CL1_1 through CL1_7 . . . CL12_1 through CL12_7. These first touch pad sets P1_1 through P1_8 . . . P12_1 through P12_8 are disposed in a y-axial direction, and are connected with the touch sensor 560 through the left-hand channels <c1:c12> and the right-hand channels <a1:a12>. Further, the lower sheet pad 540 includes the second touch pads Px1 through Px8 that extend in the y-axial direction and are disposed in an x-axial direction.

Here, the upper sheet pad 520 is illustrated to have the first touch pad sets P1_1 through P1_8 . . . P12_1 through P12_8 for 12 channels, and the lower sheet pad 540 is illustrated to have eight second touch pads Px1 through Px8. However, the upper sheet pad 520 and the lower sheet pad 540 may have as many of the first touch pads and the second touch pads as needed, respectively.

In FIG. 6, the touch sensor 560 includes first and second reference signal input/output pins out11/in12 . . . out121/in122 and in11/out12 . . . in121/out122, which alternately input reference signals into one of opposite ends of each of the first touch pad sets P1_1 through P1_8 . . . P12_1 through P12_8 and receive delayed reference signals output from the other end.

In detail, the first and second reference signal input/output pins apply first and second reference signals to, or receive delayed first and second reference signals from the first touch pad sets P1_1 through P1_8 . . . P12_1 through P12_8 through the left-hand channels <c1:c12> and the right-hand channels <a1:a12> in opposite directions.

The operation of the touch sensor device according to the fifth embodiment of the inventive concept will be described below with reference to FIG. 6.

As illustrated in FIG. 6, the first touch pad sets P1_1 through P1_8 . . . P12_1 through P12_8 have a relatively large area so as to facilitate a touch of the touch object, and have a smaller resistance value than the connection line sets CL1_1 through CL1_7 . . . CL12_1 through CL12_7. At this time, the connection line sets CL1_1 through CL1_7 . . . CL12_1 through CL12_7 are designed to have a narrow enough width, compared to the first touch pad sets P1_1 through P1_8 . . . P12_1 through P12_8. Thus, the connection line sets CL1_1 through CL1_7 . . . CL12_1 through CL12_7 have a greater resistance value than the first touch pad sets P1_1 through P1_8 . . . P12_1 through P12_8, so that this resistance value is used during the capacitor-type touch sensing operation. In other words, during the capacitor-type touch sensing operation, the touch location of the touch object is determined by the resistance values of the connection line sets CL1_1 through CL1_7 . . . CL12_1 through CL12_7 and touch capacitance of the first touch pad sets P1_1 through P1_8 . . . P12_1 through P12_8.

Meanwhile, the connection line sets CL1_1 through CL1_7 . . . CL12_1 through CL12_7 are designed to have a small enough length, compared to the tip size of the stylus touched to the touch panel 500. Thus, each of the first touch pad sets P1_1 through P1_8 . . . P12_1 through P12_8 is made narrow, so that each of the first touch pad sets P1_1 through P1_8 . . . P12_1 through P12_8 can be used as one bar-shaped pattern as if each of first touch pad sets P1_1 through P1_8 . . . P12_1 through P12_8 is continuously connected during the resistor-type multi-touch sensing operation.

For the convenience of understanding, it is assumed that the touch object is touched to the second touch pad P1_2 among the first touch pads P1_1 through P1_8 connected in series. First, in the case of the capacitor-type touch sensing operation, when the touch sensor 560 outputs a first reference signal through the first reference signal input/output pin in11/out12, and applies the output reference signal to the first touch pad P1_1 of the first touch pads P1_1 through P1_8, the first reference signal is delayed by resistance values of the first touch pads P1_1 through P1_8 and the connection lines CL1_1 through CL1_7 and by capacitance of the second touch pad P1_2 to which the touch object is touched, and is output through the last touch pad P1_8.

The touch sensor 560 receives the delayed first reference signal, compares the delayed first reference signal with the reference signal, and measures and stores a first delay time.

When the touch sensor 560 outputs a second reference signal through the second reference signal input/output pin out11/in12, and applies the output second reference signal to the last touch pad P1_8 of the first touch pads P1_1 through P1_8, the second reference signal is delayed by resistance values of the first touch pads P1_1 through P1_8 and the connection lines CL1_1 through CL1_7 and by capacitance of the second touch pad P1_2 to which the touch object is touched, and is output through the first touch pad P1_1.

The touch sensor 560 receives the delayed second reference signal, compares the delayed second reference signal with the second reference signal, and measures and stores a second delay time. Then, the touch sensor 560 compares the pre-stored first delay time with the second delay time, obtains corresponding coordinates, and outputs the coordinates as touch location data TS_OUT.

Here, the touch sensor may calculate coordinates corresponding to the first and second delay times, and obtain the touch location data TS_OUT using an average of the two coordinates. Alternatively, the touch sensor may calculate a difference between the first and second delay times to directly obtain the touch location data TS_OUT.

In this manner, the touch sensor 560 according to the fifth embodiment of the inventive concept alternately applies the first and second reference signals to the opposite ends of the first touch pad sets P1_1 through P1_8 . . . P12_1 through P12_8 of the upper sheet pad 520. The touch sensor detects delay times of the first and second reference signals delayed by the resistance values of the first touch pad sets P1_1 through P1_8 . . . P12_1 through P12_8 and the connection line sets CL1_1 through CL1_7 . . . CL12_1 through CL12_7 and by the capacitance of the touch pads to which the touch object is touched. Because the coordinates are obtained using the two delay times regardless of noise and offset, the touch location of the touch object can be accurately obtained by removing the noise and offset

Further, in the case of the capacitor-type touch sensing operation, the connection line sets CL1_1 through CL1_7 . . . CL12_1 through CL12_7 are made thin so as to increase resistance. Thereby, the touch location of the touch object is determined through the connection line sets CL1_1 through CL1_7 . . . CL12_1 through CL12_7.

In detail, each of the first touch pads P1_1, P1_2 . . . P12_8 may form one square, while each of the connection lines CL1_1, CL1_2 . . . CL12_7 may form at least three to ten squares due to a small line width. Because an indium tin oxide (ITO) layer generally has sheet resistance ranging from 300 ohms to 500 ohms per square, the resistance value for the capacitor-type touch sensing operation of the touch sensor device according to the fifth embodiment of the inventive concept can be obtained on the basis of a capacitor-type touch sensing operation principle.

Thus, the operation principle that determines the touch location of the touch object through the connection line sets CL1_1 through CL1_7 . . . CL12_1 through CL12_7 in the case of the resistor-type touch sensing operation is the same as in the case of the touch sensing operation of FIGS. 1, 3, 4 and 5, and so repeated description thereof will be omitted.

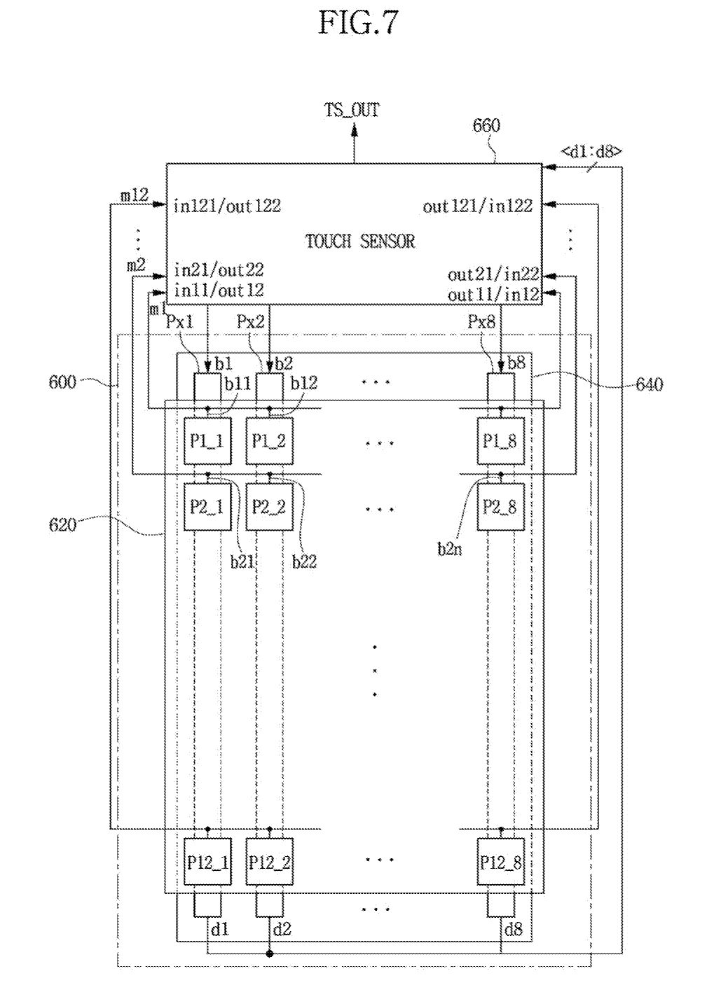

FIG. 7 illustrates the construction of a touch sensor device having resistor-type multi-touch sensing function and capacitor-type touch sensing function according to a sixth embodiment of the inventive concept. The touch sensor device includes a touch panel 600 and a touch sensor 660.

The touch sensor device of the sixth embodiment is different from that of the fifth embodiment in that a plurality of connection line sets CL1_1 through CL1_7 . . . CL12_1 through CL12_7 connected between a plurality of first touch pad sets P1_1 through P1_8 . . . P12_1 through P12_8 for the same channels are removed. Thus, the first touch pad sets P1_1 through P1_8 . . . P12_1 through P12_8 are connected through main channel lines m1 through 12 in place of the connection line sets CL1_1 through CL1_7 . . . CL12_1 through CL12_7. Other configurations are the same as in the fifth embodiment. Thus, the principle that determines the touch location of the touch object is the same as in the fifth embodiment, and so repeated description thereof will be omitted.

In this manner, the touch sensor device of the sixth embodiment can narrow the first touch pad sets P1_1 through P1_8 . . . P12_1 through P12_8 due to the removal of the connection line sets CL1_1 through CL1_7 . . . CL12_1 through CL12_7. Thus, in the case of the resistor-type multi-touch sensing operation, it is possible to make up for a low y-axial resolution caused by the square area of each of the first touch pads P1_1, P1_2 . . . P12_8.

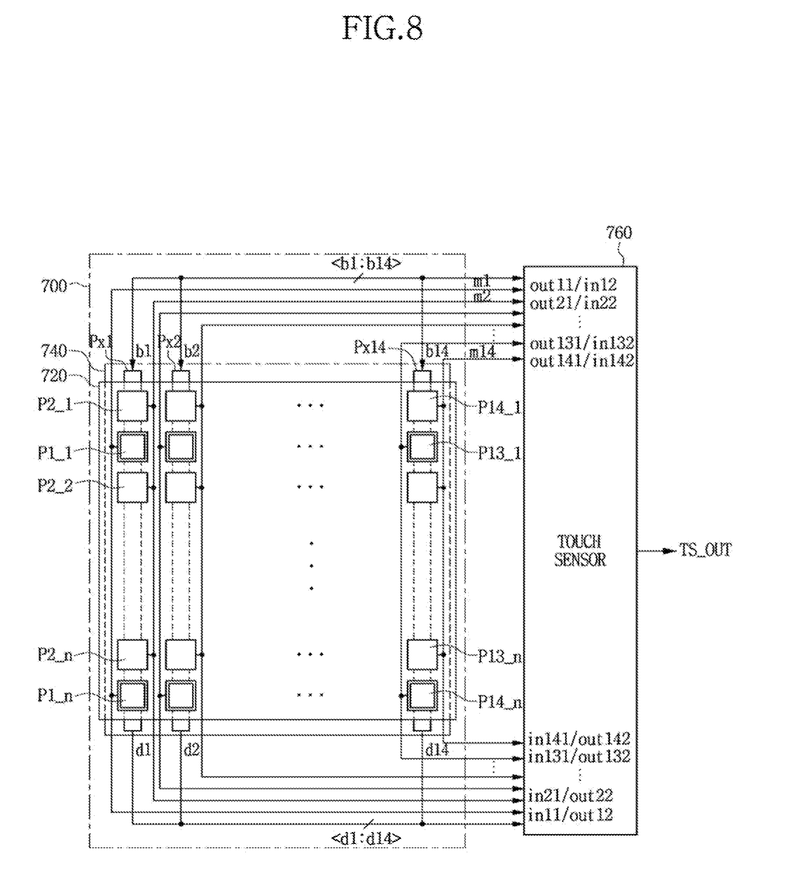

FIG. 8 illustrates the construction of a touch sensor device having five wire resistor-type multi-touch sensing function and capacitor-type touch sensing function according to a seventh embodiment of the inventive concept. The touch sensor device includes a touch panel 700 and a touch sensor 760.

Comparing the touch sensor device of the seventh embodiment with that of the sixth embodiment, the touch sensor device of the seventh embodiment increases channels for the upper sheet pad from 12 channels to 14 channels. Further, a plurality of touch pad sets P1_1 through P1_{—}n . . . P14_1 through P14_{—}n are configured such that the touch pads of the same channel are arranged alternately rather than continuously in order to prepare for excess of a y-axial resolution of capacitor-type touch sensing due to the excessive y-axial length of an upper sheet pad 720. However, the principle that determines the touch location of the touch object is the same as in the fifth embodiment, and so repeated description thereof will be omitted.

Thus, in the seventh embodiment of the inventive concept, an interval between the touch pads of the touch pad sets of the same channel increases twice. Because the channels are different from each other, a multi-touch is possible. Because the two neighboring channels are interconnected to use the touch pads as one bar-shaped pattern, the resistor-type multi-touch sensing operation is possible.

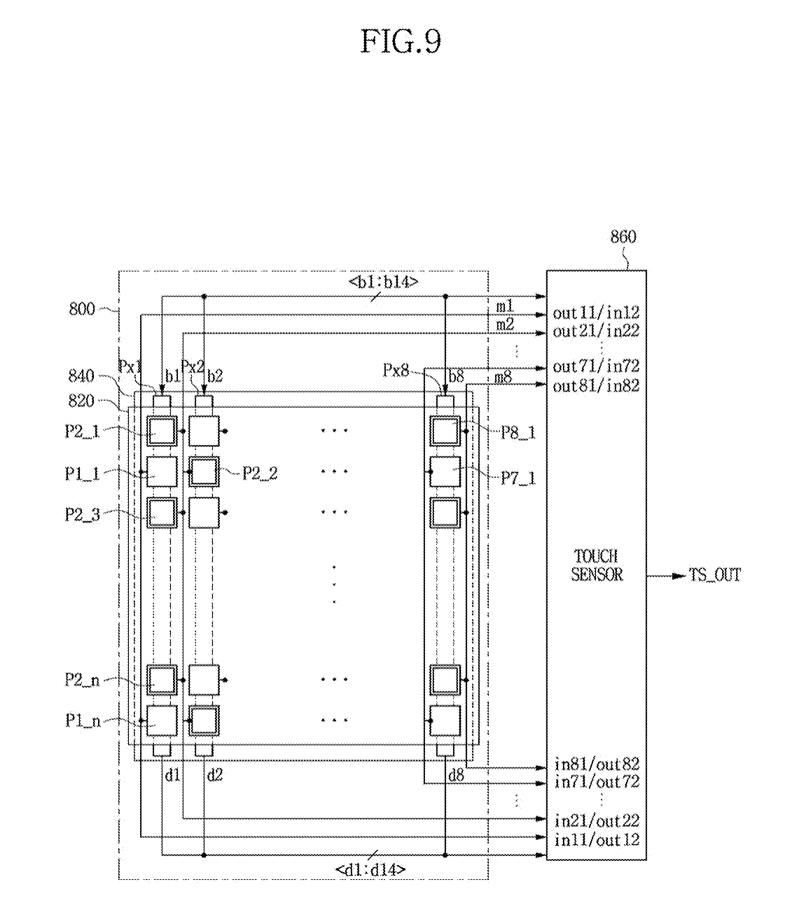

FIG. 9 illustrates the construction of a touch sensor device having five wire resistor-type single touch sensing function and capacitor-type touch sensing function according to an eighth embodiment of the inventive concept. The touch sensor device includes a touch panel 800 and a touch sensor 860.

Comparing the touch sensor device of the eighth embodiment with that of the sixth embodiment, the touch sensor device of the eighth embodiment reduces channels for the upper sheet pad from 12 channels to 8 channels. Further, a plurality of touch pad sets P1_1 through P1_{—}n . . . P8_1 through P8_{—}n are configured, for instance, so that the touch pads P2_1 through P2_{—}n of the same channel alternate with the touch pads P1_1 through P1_{—}n and P3_1 through P3_{—}n of two channels neighboring the channel in a zigzag form. However, the principle that determines the touch location of the touch object is the same as in the sixth embodiment, and so repeated description thereof will be omitted.

Thus, in the eighth embodiment of the inventive concept, an interval between the touch pads of the touch pad sets of the same channel increases twice. Because the channels are different from each other, a multi-touch is possible.

In this manner, the touch sensor devices of the inventive concept can recognize both a resistor-type multi-touch and a restricted capacitor-type multi-touch, provide both high-resolution touch sensing and low-resolution touch sensing, and detect two or more touch locations at the same time.

Further, the touch sensor devices can diversify a touch pattern to increase resolution of the touch panel. The touch sensor can alternately input first and second reference signals into opposite m ends of each touch pattern, detect delayed first and second reference signals, and obtain coordinates of a touch location using the two delayed reference signals having complementary relation. Thus, the touch sensor can accurately obtain the touch location of a touch object regardless of noise and offset.

For the convenience of understanding the capacitor-type touch mode has been described separate from the resistor-type touch mode. However, it is apparent that a combination of the two modes can be used. For example, when touch pressure of a finger touched to the touch panel is more than a predetermined value, the touch location is detected by operation of the resistor-type touch mode. In contrast, when the touch pressure is less than the predetermined value, the touch location is detected by operation of the capacitor-type touch mode.

Thus, the operation is first done in the resistor-type touch mode, and then it is detected whether the upper sheet pad comes into contact with the lower sheet pad. If so, the operation may be done only in the resistor-type touch mode.

Further, the four wire type operation has been described to sequentially operate a plurality of touch pads arranged on the lower sheet pad. However, it is apparent that the four wire type operation can be converted into a five wire type operation by using the lower sheet pad as one touch pad, by applying signals to four corners of the lower sheet pad, and by applying the touch pads to the upper sheet pad.

This five wire type operation provides a restricted multi-touch, but it can reduce processing cost of the lower sheet pad.

The foregoing is illustrative of example embodiments, and is not to be construed as limiting thereof Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims.

1. A touch sensor device comprising:
a plurality of first touch pads, each of which is connected with a first bar-type touch pattern and a second bar-type touch pattern by a plurality of bridges and is disposed in a first direction, the first bar-type touch pattern having a plurality of slits and being connected with first and second channels at opposite ends thereof respectively, the second bar-type touch pattern being connected with third and four channels at opposite ends thereof respectively,
a plurality of second touch pads, each of which is connected with fifth and sixth channels at opposite ends thereof respectively and is disposed in a second direction perpendicular to the first direction; and
a touch sensor sequentially applying reference signals to the second and fourth channels of each of the first touch pads, performing resistor-type touch sensing and capacitor-type touch sensing using resistance and capacitance values, which are varied depending on a touch location of a touch object, and generating touch location data corresponding to the touch location.

2. The touch sensor device according to claim 1, wherein the touch sensor shorts the first and third channels as well as the second and fourth channels in order to measure the resistance value generated by connection between at least one of the first touch pads and at least one of the second touch pads on performing the resistor-type touch sensing, sequentially applies the reference signals to the shorted second and fourth channels, sequentially measures delay times at the fifth and sixth channels, calculates the resistance value using the delay times, and determines the touch location of the touch object using the resistance value.

3. The touch sensor device according to claim 1, wherein the touch sensor applies the reference signal to each of the fourth channels on performing the capacitor-type touch sensing, detects a delay time of the reference signal delayed by both the capacitance value of a touch point at which the touch object is touched to at least one of the touch pads and the resistance value between a point to which the reference signal is applied and the touch point, and determines the touch location of the touch object using the delay time.

4. The touch sensor device according to claim 1, wherein the touch sensor calculates x and y coordinates of the first touch pads when the touch object is touched to neighboring ones of the first touch pads, calculates the x and y coordinates using interpolation, and determines the touch locations of the touch object.

5. A touch sensor device comprising:
a plurality of first touch pads, each of which is connected with first and second channels at opposite ends thereof, undergoes a decrease in area in a first direction, and is disposed in a second direction perpendicular to the first direction;
a plurality of second touch pads, each of which makes a pair with each of the first touch pads, is connected with third and fourth channels at opposite ends thereof, undergoes an increase in area in the first direction, and is disposed in the second direction, the third and fourth channels being disposed on the same plane as the first touch pads;
a plurality of third touch pads, each of which is connected with fifth and sixth channels at opposite ends thereof, extends in a bar-type touch pattern in the second direction, and is disposed in the first direction, the fifth and sixth channels being disposed on a plane different from those of the first and second touch pads; and
a touch sensor sequentially applying reference signals to the first and fourth channels or the second and third channels, performing resistor-type touch sensing and capacitor-type touch sensing using resistance and capacitance values, which are varied depending on a touch location of a touch object, and generating touch location data corresponding to the touch location.

6. The touch sensor device according to claim 5, wherein the touch sensor determines an x coordinate according to a ratio of capacitance values depending on the touch locations of the first and second touch pad pairs on performing the capacitor-type touch sensing, and a y coordinate according to a second-directional order of the touched touch pad pairs.

7. The touch sensor device according to claim 5, wherein the touch sensor shorts the first and third channels as well as the second and fourth channels in order to measure the resistance value generated by connection between some of the first and second touch pads and some of the third touch pads on performing the resistor-type touch sensing, sequentially applies the reference signals to the shorted first and third channels, sequentially measures the fifth and sixth channels to detect delay times of the reference signals, calculates the resistance value using the delay times, and determines the touch location of the touch object using the resistance value.

8. The touch sensor device according to claim 5, wherein the touch sensor calculates x and y coordinates of the touch pad pairs when the touch object is simultaneously touched to neighboring ones of the touch pad pairs, calculates the x and y coordinates using interpolation, and determines the touch locations of the touch object.

9. The touch sensor device according to claim 5, wherein the first and second touch pads form bar-type touch pad pairs in a symmetrical structure in which touch patterns having a shape of a right-angled triangle alternate with each other.

10. The touch sensor device according to claim 5, wherein the first and second touch pads form bar-type touch pad pairs in a symmetrical structure in which touch patterns having a shape of an isosceles triangle alternate with each other.

11. The touch sensor device according to claim 5, wherein the first and second touch pads form bar-type touch pad pairs in a symmetrical structure in which toothed touch patterns alternate with each other.

12. A touch sensor device comprising:
a plurality of first touch pads, each of which has a plurality of touch patterns disposed in a first direction and serially connected, and is connected with first and second channels at opposite ends thereof, wherein the plurality of first touch pads are disposed in a second direction perpendicular to the first direction;
a plurality of second touch pads, each of which extends in the second direction, and is connected with third and fourth channels at opposite ends thereof, wherein the plurality of second touch pads are disposed in the first direction; and
a touch sensor applying a reference signal to one end of each of the first touch pads to receive a first delay reference signal output from the other end of each of the first touch pads, applying the reference signal to the other end of each of the first touch pads to receive a second delay reference signal output from one end of each of the first touch pads, performing resistor-type touch sensing and capacitor-type touch sensing using delay time differences between the reference signal and the first delay reference signal and between the reference signal and the second delay reference signal, and generating touch location data corresponding to a touch location of a touch object.

13. The touch sensor device according to claim 12, wherein:
each of the first touch pads includes a plurality of connection lines connected between the touch patterns; and
each of the connection lines has a length shorter than a touch surface of the touch object on applying the resistor-type touch sensing such that the touch patterns form a single bar-type touch pattern, and has a width smaller than that of each touch pattern on applying the capacitor-type touch sensing.

14. The touch sensor device according to claim 12, wherein the touch sensor alternately outputs the reference signals to opposite ends of each of the first touch pads, detects the first and second delay reference signals delayed by resistance values of the touch patterns and the connection lines and capacitance of the touch location, extracts first and second delay times from the first and second delay reference signals, and obtains the touch location of the touch object using the first and second delay times.

15. The touch sensor device according to claim 14, wherein the touch sensor calculates coordinates of the touch location of the touch object corresponding to each of the first and second delay times, calculates the coordinates using interpolation, and obtains the touch location data.

16. The touch sensor device according to claim 14, wherein the touch sensor obtains the touch location data using a difference between the first and second delay times.

17. The touch sensor device according to claim 14, wherein the touch sensor obtains the touch location data using a ratio between the first and second delay times.

18. The touch sensor device according to claim 12, wherein the touch patterns for each of the first touch pads are connected to one channel line, which is connected to the first and second channels at opposite ends thereof

19. The touch sensor device according to claim 12, wherein the touch patterns are configured such that the touch patterns connected to two neighboring channel lines are alternately disposed on a same straight line on exceeding resolution of the second direction on performing the capacitor-type touch sensing so as to increase a spacing between the neighboring touch patterns.

20. The touch sensor device according to claim 12, wherein the touch patterns are configured such that the touch patterns of neighboring channel lines are alternately disposed on left and right sides of a same channel on exceeding resolution of the second direction on performing the capacitor-type touch sensing so as to increase a spacing between the neighboring touch patterns.
